(19) United States
(12) Patent Application Publication
(10) Pub. No.: US 2017/0107804 A1
(43) Pub. Date: Apr. 20, 2017

(54) HYBRID PRIME MOTIVATOR FOR ROD PUMP HYDRAULIC SURFACE UNIT

(71) Applicants: David A. Krug, Cedar Hills, UT (US); J. David Nelson, South Jordan, UT (US)

(72) Inventors: David A. Krug, Cedar Hills, UT (US); J. David Nelson, South Jordan, UT (US)

(21) Appl. No.: 14/882,457

(22) Filed: Oct. 14, 2015

(51) Int. Cl. E21B 43/12; F04B 17/03; H02J 7/32; F04B 47/04; F04B 53/14; H02J 7/00; F04B 9/103; F04B 19/22

(52) U.S. Cl. CPC E21B 43/126; F04B 9/103; F04B 17/03; F04B 19/22; F04B 47/04; F04B 53/14; H02J 7/0068; H02J 7/32

(57) ABSTRACT

A hybrid prime motivator system for a hydraulic surface unit of a rod pump for an oil well or gas well which incorporates a positive displacement hydraulic pump having hydraulic fluid flow control capability, a motor-generator mechanically coupled to the positive displacement hydraulic pump, a hybrid energy system electrically connected to the motor-generator, the hybrid energy system having an energy supply capability for supplying energy to the motor-generator during a rod pump up stroke, an energy receiving capability for receiving and storing energy generated by the motor-generator during a rod pump down stroke, and a replacement energy generating capability for generating replacement energy to replace energy lost during successive rod pump cycles, and a hybrid motivator control module.

### BACKGROUND

This invention is in the field of energy supply systems and prime motivators for remote pumping systems, and in particular in the field of energy supply systems and prime motivators for hydraulic surface units for remote oil and gas well rod pumps.

Rod pumping systems are widely used in the oil and gas production industry. Such has been the case since the early 1900's. Rod pumping systems are important for fluid pumping conditions and formation conditions frequently experienced in many oil fields and gas fields around the world. For instance, rod pumping systems are frequently deployed where oil wells or gas wells are experiencing a low to moderate rate of fluid production, both as an original pumping system for a new oil well or gas well, or a replacement pumping system for an oil well or gas well previously in production for which the fluid production rate has declined.

A rod pumping system is comprised of five basic components, a pumping unit, a rod string, a tube string, a surface unit, and a fluid receiving unit. The positive displacement, reciprocating plunger pumping unit is positioned in the oil well or gas well below the surface of the fluid being pumped. The rod string of sucker rods extends from the pumping unit to the surface. The rod string connects the pumping unit to the surface unit, the source of energy for the rod pumping system. The tube string transmits fluid from the pumping unit to the surface and the fluid receiving unit. The surface unit causes the rod string to move generally up and down in the well, thereby imparting a reciprocating motion to the plunger in the pumping unit, regardless of whether the pumping unit is installed vertically, horizontally, or some other angle in the producing formation.

Electric motors are by far the preferred prime motivator for a prime motivator system for a rod pump. These are several types of rod pump surface units, which varying initial cost, operating cost, reliability, and operational simplicity. Mechanical surface units incorporate a counter weight which is raised by the surface unit as the rod string is lowered, thereby storing potential energy in counter weight, which potential energy is used to assist the raising of the rod string during the up stroke as the counter weight is lowered. This reduces both the peak power demand and the overall energy consumption of the mechanical surface unit.

The hydraulic surface unit of U.S. Pat. Nos. 8,083,499 and 8,562,308 to Krug et. al., hereafter referred to as the “Krug Hydraulic Surface Unit”, manufactured and sold by Rodmax Oil & Gas, Inc., provides for the recovery, during the rod pump downstroke, of a high percentage of the energy input by the hydraulic surface unit during the rod pump up stroke. During the rod pump down stroke, the motor acts as a generator, extracting energy from the hydraulic pump of the hydraulic surface unit.

In many geographical areas where oil fields and gas fields have been in development and production for many years, an electric power grid is available for both the purposes of supplying power to the electric motor of the hydraulic surface unit during the rod pump up stroke and receiving the power generated by the electric motor during the rod pump down stroke. However, with the rapid development of new oil fields and gas fields in remote areas of the world, including the United States, there are many new wells that are being developed which do not have an electric power grid available.

The use of a diesel or natural gas engine to provide energy for a surface unit has serious initial costs, operating costs, reliability, and operational complexity disadvantages. Further, such a prime motivator system, offers very limited opportunity for the recapture of energy during the rod pump down stroke.

The development and advancement of hybrid energy systems has been furthered in recent years by the advancements made in the battery technology, particularly lithium battery technology, which has substantially improved and further advances are anticipated. Likewise, substantial advancements in the development of super-capacitors have been noted in recent years, and further advances in capacitor technology are anticipated.

Hydraulic surface units, including in particular the Krug Hydraulic Surface Unit, are particularly well suited for the application of hybrid energy technology. In fact, the repetitive, cyclical, and predictable nature of rod pumping, as well as the relatively short time duration of each cycle, typically less than 10 seconds, make hydraulic surface units, including particularly the regenerative Krug Hydraulic Surface Units, particularly well suited for the application of hybrid energy systems technology. By comparison, hybrid motor vehicles require service over a wide range of power and energy consumption conditions, such as stop and go traffic, variable grades, long upgrades, steep upgrades, and long down grades. The service demands for the hybrid energy system of an automobile, are therefore highly variable, unpredictable, and the battery system must provide for a long term storage capability. Further, such applications are not well suited for the use of capacitors, for meeting a significant portion of the energy storage requirements. By contrast, the cyclical, predictable, uniform and short duration cycles of a hydraulic surface unit are particularly adaptable to the utilization of capacitors for a substantial portion of the energy storage. The rapid charging and discharging capabilities of capacitors, in contrast to battery systems, make them advantageous for utilization for a hybrid energy system for hydraulic surface units.

It is an objective of the present invention to provide a hybrid prime motivator system for a rod pump hydraulic surface unit, including particularly the Krug Hydraulic Surface Unit.

It is a further objective of the present invention to provide a hybrid energy supply system for a rod pump hydraulic surface unit, including particularly the Krug Hydraulic Surface Unit.

### SUMMARY OF THE INVENTION

The hybrid prime motivator system of the present invention incorporates a motor-generator, which, for certain preferred embodiments, may be directly coupled to the hydraulic pump of a hydraulic surface unit by a mechanical coupling. Power is supplied to the motor-generator during the rod pump up stroke from an energy storage assembly, which supplies up stroke DC (direct current) power to an inverter-converter, which in turn supplies up stroke AC (alternating current) power to the motor-generator.

During the rod pump down stroke, the hydraulic pump swallows hydraulic fluid and outputs energy to the motor-generator through the mechanical coupling. During the rod pump down stroke, the motor-generator generates down stroke AC power, which is converted by the inverter-converter to down stroke DC power, which flows to the energy storage assembly.

Preferred embodiments of the hydraulic pump provide for axial rotation in the same direction regardless of whether the motor-generator is receiving up stroke AC power and the hydraulic pump is pumping fluid, or the hydraulic pump is swallowing fluid and the motor-generator is generating down-stroke AC power. The types of hydraulic pumps that may be used include axial piston pumps, bent axis piston pumps, radial piston pumps, vane pumps, and any other type of positive displacement hydraulic pump that has a capability for controllable, variable flow rate discharge of fluid from the pump work port, and controllable, variable flow rate swallowing of fluid at the pump work port. The hybrid prime motivator system of the present invention is particularly well suited for application with the rod pump regenerative hydraulic surface unit of U.S. Pat. No. 8,083,499 and U.S. Pat. No. 8,562,308 to Krug (the present inventor) et al., and U.S. Pat. No. 8,844,626 to Krug. For this preferred embodiment, the hybrid prime motivator system incorporates a positive displacement hydraulic pump, preferably having a swash plate and swash plate pitch control for variable hydraulic fluid flow control.

Replacement energy to replace the energy lost due to the respective inefficiencies of the components of the hybrid prime motivator system of the present invention, the inefficiency of the other components of the hydraulic surface unit, and the energy consumed by the rod pump in completing a pumping cycle of the rod pump, is supplied by the replacement energy generation assembly. The replacement energy generation assembly may include a replacement energy motivator and a replacement energy generation device. The replacement energy motivator may consist of a replacement engine which may be a diesel or a natural gas engine, or other types of energy producing devices which will be known to persons skilled in the art. The replacement energy generation device may be a DC or an AC generation device of a number of types presently available or developed in the future, that will be known to persons of skill in the art. Based upon current technology, a replacement energy generation assembly which is preferred by the present inventor is a commonly known and widely used industrial generator system known in the industry as a gen-set. A gen-set typically has a diesel or natural gas engine, which is controlled to operate at a generally constant rpm, and an energy generation device that produces AC current at a pre-set and generally constant voltage.

Replacement energy produced by the replacement energy generation assembly is directed to a replacement energy convertor, which produces replacement DC power. Two or more replacement energy switches, a first replacement switch and a second replacement switch, controlled by a hybrid motivator control module, may be used direct the replacement DC power, as replacement storage DC power to the energy storage assembly, typically during the rod pump down stroke, or as bypass replacement DC power by a replacement bypass circuit directly to the inverter-converter, along with DC power from the energy storage assembly, typically during the rod pump up stroke, for the production by the inverter-converter of AC power to energize the motor-generator.

During the rod pump up stroke, up stroke DC power may be provided by both replacement energy generation assembly and by the energy storage assembly to the inverter-converter to supply the necessary up stroke AC power for the hybrid prime motivator system motor-generator to power the hydraulic pump. During the rod pump down stroke, replacement DC power from the replacement energy generation assembly may be directed to the energy storage assembly concurrently with the DC power from the inverter-converter and the motor-generator acting as the generator. Therefore, the replacement energy motivator and replacement energy generation assembly simply replace the energy lost due to the overall inefficiencies of the rod pump, hydraulic surface unit, and hybrid energy system.

For preferred embodiments of the motor-generator of the hybrid prime motivator system, an AC synchronous motor may be preferred, because the efficiency both of the motor and the generator functions of the motor-generator may be higher than that of other types of motors. However, an AC induction motor, a brush-less DC motor, a synchronous DC motor, or other new and high technology motors, including motors which incorporate features of more than one type of motor, may be utilized. Any motor which is capable of also serving as a generator and providing for uptake of energy from the hydraulic pump as it swallows hydraulic fluid during the rod pump downstroke may be utilized as the motor-generator.

The energy storage assembly may consist of a number of embodiments incorporating batteries, capacitors, switches and other components which will be known to persons of skill in the art, based upon present technology. Also, further advances in battery and capacitor technology will undoubtedly provide other options for the energy storage assembly. Based upon present technology, preferred embodiments may utilize an energy storage assembly incorporating one or more batteries, one or more capacitors, and one or more energy storage switches for directing the current to and from the batteries and the capacitors as needed to supply power to the motor-generator during the rod pump up stroke, and to receive and store power during the rod pump down stroke. The energy storage switches may be controlled by an energy storage assembly switch controller. The energy storage assembly may also incorporate voltage sensors and current sensors which provide data to the energy storage assembly switch controller for use in controlling the energy storage switches.

An alternative embodiment of a hybrid prime motivator system of the present invention may incorporate a parallel replacement engine assembly having a replacement energy motivator which is directly connected to the hydraulic pump in parallel with the motor-generator.

For this embodiment, up stroke DC power flows from the energy storage assembly to the inverter-converter, and up stroke AC power flows from the inverter-converter to the motor-generator and powers the hydraulic pump during the rod pump up stroke. Replacement energy is provided by the replacement energy motivator, which may include any additional power required by the hydraulic pump during the rod pump up stroke that is not available from the energy storage assembly. During the rod pump down stroke, the replacement energy motivator may provide additional energy through the replacement energy engagement device to the hydraulic pump. This, together with the energy extracted from the rod pump during the rod pump down stroke, results in the generation of downstroke AC power to the inverter-converter and downstroke DC power to the energy storage assembly which may restore the energy level of the energy storage assembly to the level required for the next rod pump up stroke.

A further alternative preferred embodiment of the hybrid prime motivator system may provide for the energy storage assembly and the replacement energy generation assembly to be connected in parallel to the inverter-converter through a power interface. The power interface may be a mere electrical junction box or may incorporate one or more switches and one or more sensors to control the flow of DC current from the energy storage assembly and the replacement energy generation assembly. During the rod pump up stroke, the energy storage assembly produces storage assembly DC power which is directed to the energy storage controller. The energy storage controller may direct all of the energy storage DC power to power interface as storage controlled DC power. Down stroke AC power generated by the motor-generator during the rod pump down stroke is received by the inverter-converter and converted to down stroke DC power which flows to the power interface. The down stroke DC power is combined with any replacement DC power being produced by the replacement energy generation assembly during the rod pump down stroke to constitute combined down stroke DC power. Surplus energy may be dissipated by a surplus energy dissipation assembly to prevent overcharging of the energy storage assembly. The operation of the energy storage controller and the replacement energy generation assembly may be controlled by a hybrid motivator control module.

### BRIEF DESCRIPTION OF THE DRAWINGS

FIG. 1 is a block diagram schematic of a preferred embodiment of a hybrid prime motivator system of the present invention for a rod pump hydraulic surface unit.

FIG. 2 is a block diagram schematic of an alternative embodiment of a hybrid prime motivator system of the present invention for a rod pump hydraulic surface unit, incorporating a replacement energy motivator and a motor-generator directly mechanically connected in parallel to the hydraulic pump of the rod pump hydraulic surface unit.

FIG. 3 is a block diagram schematic of a preferred embodiment of a hybrid prime motivator system of the present invention for a rod pump hydraulic surface unit, the hybrid prime motivator system incorporating a Gen-set connected in parallel with an energy storage assembly, and incorporating a surplus energy dissipation assembly.

FIG. 4 is a block diagram schematic of an alternative embodiment of a hybrid prime motivator system of the present invention for a rod pump hydraulic surface unit as shown in FIG. 2, incorporating a replacement energy motivator and a motor-generator directly mechanically connected in parallel to the hydraulic pump of the rod pump hydraulic surface unit, and further incorporating a surplus energy dissipation assembly.

### DETAILED DESCRIPTION

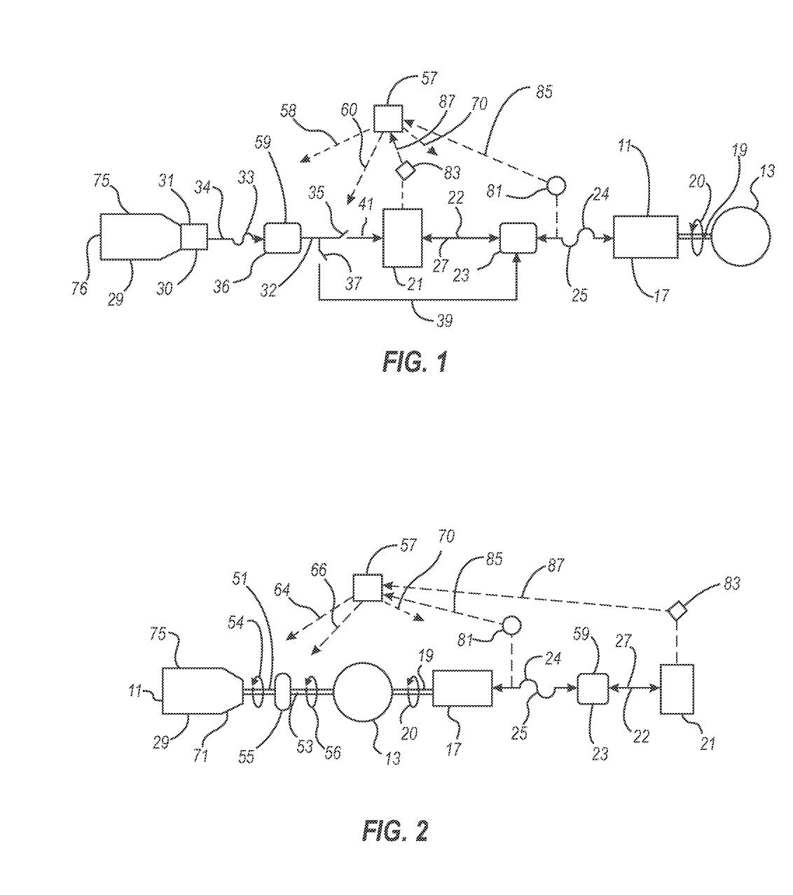

Referring first to FIG. 1 a preferred embodiment of the hybrid prime motivator system 11 is shown. For this embodiment of the hybrid prime motivator system 11, the hydraulic pump 13 of a hydraulic surface unit may be directly coupled to the motor-generator 17 of the hybrid prime motivator system 11 by a mechanical coupling 19. Power is supplied to the motor-generator 17, during the rod pump up stroke, from the energy storage assembly 21, which supplies up stroke DC (direct current) power 22 to an inverter-converter 23, which in turn supplies up stroke AC (alternating current) power 24 to the motor-generator 17.

During the rod pump down stroke, the hydraulic pump 13 swallows hydraulic fluid and outputs energy to the motor-generator 17 through the mechanical coupling 19. During the rod pump down stroke, the motor-generator 17 generates down stroke AC power 25, which is converted by the inverter-converter 23 to down stroke DC power 27, which flows to the energy storage assembly 21.

Preferred embodiments of the hydraulic pump 13 provide for mechanical coupling axial rotation 20 in the same direction regardless of whether the motor-generator 17 is receiving up stroke AC power 24 and the hydraulic pump 13 is pumping fluid, or the hydraulic pump 13 is swallowing fluid and the motor-generator 17 is generating down-stroke AC power 25. The types of hydraulic pumps that may be used for the hydraulic pump 13 of preferred embodiments of the present invention include axial piston pumps, bent axis piston pumps, radial piston pumps, vane pumps, and any other type of positive displacement hydraulic pump that has a capability for controllable, variable flow rate discharge of fluid from the pump work port, and controllable, variable flow rate swallowing of fluid at the pump work port.

Replacement energy 33 to replace the energy lost due to the respective inefficiencies of the components of the hybrid prime motivator system 11 of the present invention, the inefficiency of the other components of the hydraulic surface unit, and the energy consumed by the rod pump in completing a pumping cycle of the rod pump, is supplied by the replacement energy generation assembly 31. The replacement energy generation assembly 31 may include a replacement energy motivator 29 and a replacement energy generation device 30. The replacement energy motivator 29 may consist of a replacement engine 75 which may be a diesel or a natural gas engine, or other types of energy producing devices which will be known to persons skilled in the art. The replacement energy generation device 30 may be a DC or an AC generation device of a number of types presently available or developed in the future, that will be known to persons of skill in the art. Based upon current technology, a replacement energy generation assembly 31 which is preferred by the present inventor is a commonly known and widely used industrial generator system known in the industry as a gen-set 76 which has been used for the schematic of FIG. 1. A gen-set 76 typically has a diesel or natural gas engine, which is controlled to operate at a generally constant rpm, and an energy generation device that produces AC current at a pre-set and generally constant voltage.

Replacement energy 33 produced by the replacement energy generation assembly 31, which, for the embodiment of FIG. 1, is replacement AC power 34 produced by a gen-set 76, is directed to the replacement energy convertor 36, which produces replacement DC power 32. Two or more replacement energy switches, including a first replacement switch 35 and a second replacement switch 37 may be used direct the replacement DC power 32, as replacement storage DC power 41 to the energy storage assembly 21, typically during the rod pump down stroke, or as bypass replacement DC power by the replacement bypass circuit 39 directly by to the inverter-converter 23, typically during the rod pump up stroke, for the production by the inverter-converter of AC power to energize the hybrid prime motivator system 11 motor-generator 17.

The first replacement switch 35 and the second replacement switch 37 may be controlled by a hybrid motivator control module 57 which transmits a replacement switch control signal 60 to the first replacement switch 35 and the second replacement switch 37. A battery voltage sensor 83 may provide a battery voltage signal 87 to the hybrid motivator control module 57 which the hybrid motivator control module 57 may use in determining a replacement generator control signal 58 as well as the replacement switch control signal 60. A motivator current sensor 81 may be used to monitor the magnitude and direction of the current to and from the motor-generator 17, i.e. the up stroke AC power 24 and the down stroke AC power 25, and to transmit a motivator current signal to the hybrid motivator control module 57 for use in generating the replacement generator control signal 58 and the replacement switch control signal 60. Other DC or AC sensors may be incorporated in the hydraulic surface unit circuitry to further enhance the effectiveness and efficiency of the hybrid prime motivator system 11 of the present invention as well as the overall effectiveness and efficiency of the hydraulic surface unit, which will be known to persons of skill in the art in view of the disclosures of this specification and the drawings.

Therefore, during the rod pump up stroke, up stroke DC power 22 may be provided by both replacement energy generation assembly 31 and by the energy storage assembly 21 to the inverter-converter 23 to supply the necessary up stroke AC power 24 for the hybrid prime motivator system 11 motor-generator 17 to power the hydraulic pump 13, through the mechanical coupling 19. During the rod pump down stroke, replacement DC power 32 from the replacement energy generation assembly 31 may be directed to the energy storage assembly 21 concurrently with the DC power from the inverter-converter 23 and the hybrid prime motivator system 11 motor-generator 17 acting as the generator. Therefore the replacement energy motivator 29 and replacement energy generation assembly 31, which, for the embodiment shown in FIG. 1, is a gen-set 76, simply replace the energy lost due to the overall inefficiencies of the rod pump, hydraulic surface unit, and hybrid energy system.

Although the embodiment of the hybrid prime motivator system 11 of the present invention shown in FIG. 1 incorporates a mechanical coupling 19 for transferring energy from the motor-generator 17 to the hydraulic pump 13 during the rod pump up stroke, and for transferring energy from the hydraulic pump 13 to the motor-generator 17 during the rod pump down stroke, gear boxes, transmissions, magnetic transmissions and other devices for linking the motor-generator 17 to the hydraulic pump 13 and for providing for two-way energy transfer between the motor-generator 17 and the hydraulic pump 13 will be known to a person of skill in the art in view of the disclosures made herein.

For preferred embodiments of the motor-generator 17 of the hybrid prime motivator system 11, an AC synchronous motor may be preferred, because the efficiency both of the motor and the generator functions of the motor-generator 17 may be higher than that of other types of motors, such as a typical AC induction motor, a brush-less DC motor, or a synchronous DC motor. However, an AC induction motor, a brush-less DC motor, or a synchronous DC motor may be used effectively as the motor-generator 17. Furthermore, other new and high technology motors, including motors which incorporate features of more than one type of motor, may be utilized. Any motor which is capable of also serving as a generator and providing for uptake of energy from the hydraulic pump 13 as it swallows hydraulic fluid during the rod pump downstroke may be utilized as the motor-generator 17.

An alternative embodiment of the hybrid prime motivator system 11 of the present invention, utilizes a synchronous DC motor, and a total DC power system, thereby eliminating the need for an inverter. Although this embodiment may provide some initial cost savings, the efficiency of the hybrid prime motivator system may be less than for an embodiment incorporating a typical AC induction motor and substantially less than for an embodiment incorporating a synchronous motor.

Referring further to FIG. 1, the energy storage assembly 21 may consist of a number of embodiments incorporating batteries, capacitors, switches and other components which will be known to persons of skill in the art, based upon present technology. Also, further advances in technology will undoubtedly provide other options for the energy storage assembly 21. Battery technology is rapidly advancing, resulting in both an increase in the energy storage capacity and the charging and discharging rate of batteries. However, based upon present technology, batteries cannot match the rapid charging and discharging rates of capacitors. Based upon present technology, incorporating capacitors in the energy storage assembly 21 and utilizing the inherently rapid charging and discharging rates of capacitors, may provide advantages for the energy storage assembly 21 of the present invention. Capacitor technology is also improving rapidly at the present time. The cyclical, predictable, uniform and short duration cycles of a hydraulic surface unit are particularly adaptable to the utilization of capacitors for a substantial portion of the energy storage. The rapid charging and discharging capabilities of capacitors make them advantageous for utilization for a hybrid energy system for hydraulic surface units.

Based upon present technology, preferred embodiments may utilize an energy storage assembly 21 incorporating one or more batteries, one or more capacitors, and one or more energy storage switches for directing the current to and from the batteries and the capacitors as needed to supply power to the motor-generator 17 during the rod pump up stroke, and to receive and store power during the rod pump down stroke. The energy storage switches may be controlled by an energy storage assembly switch controller. The energy storage assembly 21 may also incorporate voltage sensors and current sensors which provide data to the energy storage assembly switch controller for use in controlling the energy storage switches.

The energy storage assembly 21 may incorporate a plurality of capacitors or a plurality of batteries, or both, interconnected by energy storage switches, which may provide for parallel or series charging or discharging of selected batteries and capacitors so as to effectively and efficiently manage the discharging and charging of the energy storage assembly 21 and to control the voltage of the up stroke DC power 22 as supplied to the inverter-converter 23. Simplified embodiments of the energy storage assembly 21 may utilize only one or more batteries or only one or more capacitors.

A number of embodiments of the energy storage assembly 21 that will satisfy the energy delivery and energy storage requirements for the energy storage assembly 21 will be known to persons of skill in the art, in view of the disclosures of this specification and the drawings. The claims are not limited to any particular embodiments of the energy storage assembly 21.

An energy loss calculator may be incorporated with the hybrid motivator control module 57 for computing the energy loss during each rod pump cycle and a cumulative energy loss for use in controlling the operation of the replacement energy motivator 29 so as to provide adequate power to a hydraulic surface unit for each rod pump cycle and to maintain the voltage and energy storage of the energy storage assembly 21. The hybrid motivator control module 57 may also monitor voltage or current at other locations in the hybrid prime motivator circuit 59. The hybrid motivator control module 57 may also monitor temperature of the batteries, the capacitors, and other components of the hybrid prime motivator system 11 and provide for excess temperature slowdown or excess temperature shutdown to protect components from thermal damage.

Referring now to FIG. 2, a block diagram schematic of an alternative embodiment of a hybrid prime motivator system 11 of the present invention for a rod pump hydraulic surface unit is shown. The energy storage assembly 21 provides up stroke DC power 22 to the invertor-converter 23 which converts the up stroke DC power 22 to up stroke AC power 24 to power the motor-generator during the rod pump up stroke. For the embodiment shown, a mechanical coupling 19 connects the motor-generator to the hydraulic pump 13.

For this alternative embodiment, a parallel replacement engine assembly 71 having a replacement energy motivator 29 is directly connected to the hydraulic pump 13 in parallel with the motor-generator 17. For the embodiment shown, the replacement energy motivator 29 is a replacement engine 75 directly connected to the hydraulic pump 13.

For this embodiment of the hybrid prime motivator system 11, both the motor-generator 17 and the replacement energy motivator 29 are directly coupled to the hydraulic pump 13 of the hydraulic surface unit. For the embodiment shown in FIG. 2, the replacement energy motivator 29 is mechanically connected to the hydraulic pump 13 by replacement energy engagement device 55. The replacement energy engagement device 55 may be a clutch, gear box, transmission, magnetic transmission, or other energy transmission device for transmitting power from the replacement energy motivator 29 to the hydraulic pump 13 known to persons of skill in the art in view of the disclosures of this specification and the drawings.

For this embodiment, up stroke DC power 22 flows from the energy storage assembly 21 to the inverter-converter 23, and up stroke AC power 24 flows from the inverter-converter 23 to the motor-generator 17 and powers the hydraulic pump 13 during the rod pump up stroke. Replacement energy is provided by the replacement energy motivator 29, which may include any additional power required by the hydraulic pump 13 during the rod pump up stroke that is not available from the energy storage assembly 21. During the rod pump down stroke, the replacement energy motivator 29 may provide additional energy through the replacement energy engagement device 55 to the hydraulic pump 13. This, together with the energy extracted from the rod pump during the rod pump down stroke, results in the generation of downstroke AC power 25 to the inverter-converter 23 and downstroke DC power 27 to the energy storage assembly 21 which may restore the energy level of the energy storage assembly 21 the level required for the next rod pump up stroke.

As stated for the embodiment of the hybrid prime motivator 29 shown in FIG. 1, the replacement engine 75 may be a diesel engine, a natural gas engine, or other energy production systems known to persons skilled in the art, in view of the disclosures of this specification and the drawings. For the preferred embodiment shown in FIG. 2, the replacement engine 75 may be mechanically connected to the replacement energy engagement device 55 by a motivator mechanical coupling 51, and the replacement energy engagement device 55 may be mechanically connected to the hydraulic pump 13 by an engagement mechanical coupling 53. For the preferred embodiment of the hybrid prime motivator system 11 shown in FIG. 2, replacement engine axial rotation 54, engagement device axial rotation 56, and mechanical coupling axial rotation 20 are in the same direction. Further, as for the embodiment of FIG. 1 and for other preferred embodiments, the direction of rotation of the hydraulic pump 13 is the same regardless of whether the hydraulic pump 13 is pumping fluid during the rod pump up stroke or is swallowing fluid during the rod pump down stroke. Accordingly, the direction of replacement engine axial rotation 54, engagement device axial rotation 56, and mechanical coupling axial rotation 20 do not change regardless of whether the hydraulic pump 13 is pumping fluid or swallowing fluid.

For the embodiment shown in FIG. 2, a hybrid motivator control module 57, a battery voltage sensor 83 may provide a battery voltage signal 87 to the hybrid motivator control module 57 which the hybrid motivator control module 57 may use in determining a replacement energy motivator control signal 64 as well as an engagement device control signal 66. A motivator current sensor 81 may be used to monitor the magnitude and direction of the current to and from the motor-generator 17, i.e. the up stroke AC power 24 and the down stroke AC power 25, and to transmit a motivator current signal 85 to the hybrid motivator control module 57 for use in generating the replacement energy motivator control signal 64 and the engagement device control signal 66.

As for the embodiment shown in FIG. 1, an energy loss calculator may be incorporated for computing the energy loss during each rod pump cycle and a cumulative energy loss for use in controlling the operation of the replacement energy motivator 29 so as to provide adequate power to a hydraulic surface unit for each rod pump cycle and to maintain the voltage and energy storage of the energy storage assembly 21. The hybrid motivator control module 57 may also monitor voltage or current at other locations in the hybrid prime motivator circuit 59.

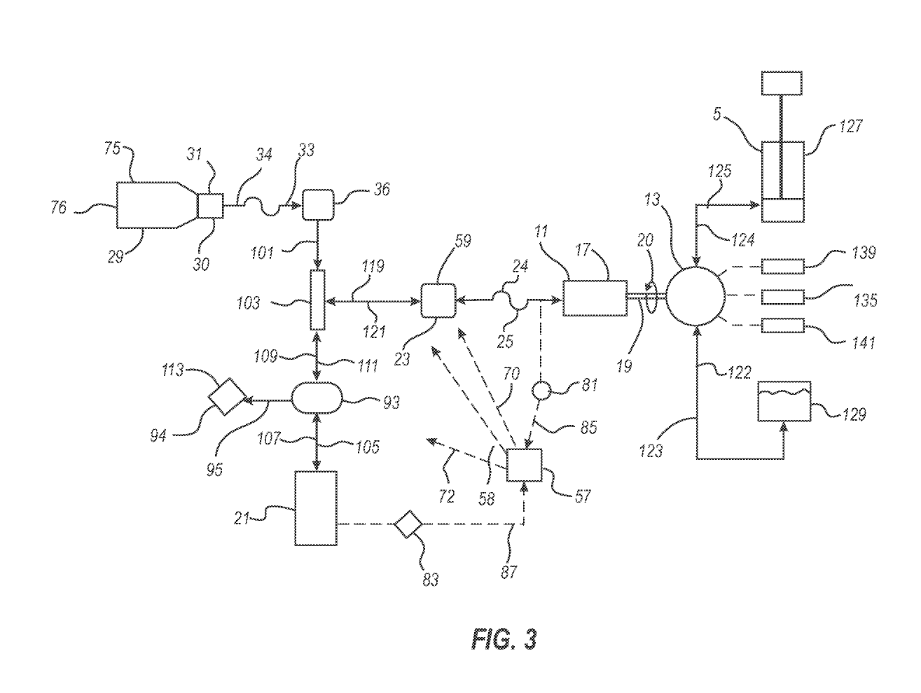

Referring now to FIG. 3, a schematic of an alternative preferred embodiment of the hybrid prime motivator system 11 is shown. For this embodiment of the hybrid prime motivator system 11, the energy storage assembly 21 and the replacement energy generation assembly 31 are connected in parallel to the inverter-converter 23 through a power interface 103. The power interface 103 may be a mere electrical junction box or may incorporate one or more switches and one or more sensors to control the flow of DC current from the energy storage assembly 21 and the replacement energy generation assembly 31. During the rod pump up stroke, the energy storage assembly 21 produces storage assembly DC power 105 which, for the embodiment shown, is directed to the energy storage controller 93. The energy storage controller 93 may direct all of the energy storage DC power 105 to power interface 103 as storage controlled DC power 109.

As described above for the embodiment of FIG. 1, the replacement energy generation assembly 31 may incorporate a replacement energy motivator 29 and a replacement energy generation device 30. The replacement energy motivator 29 may consist of a replacement engine 75 which may be a diesel or a natural gas engine, or other types of energy producing devices which will be known to persons skilled in the art. Under present technology, for preferred embodiments, the replacement energy generation assembly 71 may consist of a standard gen-set 76. A gen-set 76 typically has a diesel or natural gas engine, which is controlled to operate at a generally constant rpm, and an energy generation device that produces AC current at a pre-set and generally constant voltage. Other options for the replacement energy generation assembly 31 will be known to persons of skill in the art, in view of the disclosures of this specification and the drawings.

Replacement energy 33 produced by the replacement energy generation assembly 31, which, for the embodiment of FIG. 3, is in the form of replacement AC power 34 produced by a gen-set 76, is directed to the replacement energy convertor 36, which transmits replacement DC power 101. The replacement DC power 101 may be combined with storage controlled DC power 109 at power interface 103 to flow as up stroke DC power 119 to the inverter-converter 23. The inverter-converter 23 produces up stroke AC power 24, from the up stroke DC power 119, which is supplied to the motor-generator 17 during the rod pump up stroke. The motor-generator 17 may be connected to the hydraulic pump 13 by mechanical coupling 19, or other mechanical energy transfer device, to provide the energy needed to power the hydraulic pump 13 during the rod pump up stroke.

Referring further to FIG. 3, for illustration purposes, during the rod pump up stroke, the hydraulic pump 13, in a pumping configuration 139, may receive minimally pressurized inflow fluid 122 from a fluid reservoir 129, and transmit pressurized outflow fluid 124 to a rod pump lifting mechanism 127, such as that disclosed in U.S. Pat. Nos. 8,083,499 and 8,562,308 to Krug et. al. During the rod pump down stroke, the hydraulic pump 13, in a fluid receiving configuration 141, may receive pressurized inflow fluid 125, providing for the hydraulic pump 13 to extract energy from the pressurized inflow fluid 125 and transfer energy to the motor-generator 17 through the mechanical coupling 19. Minimally pressurize outflow fluid 123 is transmitted to the fluid reservoir 129 as the pumping cycle is completed.

A typical hydraulic pump 13 used for a hydraulic surface unit has an over center variable displacement regulator system which is in communication with and is controlled by a surface unit master controller. The displacement regulation system is able to infinitely position the displacement device from 0 to 100% positive 139 and from 0 to 100% negative 141. At 100% positive 139 the hydraulic pump 13 produces the maximum discharge flowrate for the pressurized outflow fluid 124. At 100% negative 141 the hydraulic pump 13 swallows the hydraulic fluid at a maximum intake flowrate for the pressurized inflow fluid 125.

Down stroke AC power 25 generated by the motor-generator 17 during the rod pump down stroke is received by the inverter-converter 23 and converted to down stroke DC power 121 which flows to the power interface 103. The down stroke DC power 121 is combined with any replacement DC power 101 being produced by the replacement energy generation assembly 31 during the rod pump down stroke to constitute combined down stroke DC power 111.

The energy storage controller 93 of a surplus energy dissipation assembly 94, based upon a storage controller signal 72 from the hybrid motivator control module 57, may direct all of the combined down stroke DC power 111 as storage input DC power 107 to the energy storage assembly 21, may direct a portion of the combined down stroke DC power 111 as storage input DC power 107 to the energy storage assembly 21 and a portion of the combined down stroke DC power 111 as surplus power 95 to an excess energy dissipation device 113, or may direct all of the combined down stroke DC power 111 as surplus power 95 to the excess energy dissipation device 113. It is anticipated that excess energy dissipation device 113 preferably may serve primarily only as a safety device to prevent overcharging of the batteries or capacitors of the energy storage assembly 21. For a preferred embodiment of the replacement energy generation assembly 31, the replacement energy generation assembly 31, which may preferably incorporate a gen-set 76, the minimum power production rate with the gen-set 76 idling will be less than the power production rate required for the replacement energy generation assembly 31, together with the down stroke DC power 121 generated by the motor-generator 17 through the inverter-converter during the rod pump down stroke, to restore the batteries and capacitors of the energy storage assembly 21 to a fully charged condition during the rod pump down stroke and prior to commencement of the rod pump up stroke. However, events such as an unexpected shutdown of the hydraulic surface unit or an unexpected change in the operating conditions with the replacement energy generation assembly 31 running, could result in excess energy being transmitted to the energy storage assembly 21 and a resultant overcharging of the batteries or capacitors of the energy storage assembly 21.

For the embodiment shown in FIG. 3, the operation of the energy storage controller 93 and the replacement energy generation assembly 31 may be controlled by a hybrid motivator control module 57 which may transmit a replacement generator control signal 58 to the replacement energy generation assembly 31. The replacement generator control signal 58 may be received by the voltage replacement energy convertor 36 which may have a capability of adjusting the output of the replacement DC power 101 or merely the capability of temporarily terminating the transmission of the replacement DC power 101 based upon the replacement generator control signal 58. A battery voltage sensor 83 may provide a battery voltage signal 87 to the hybrid motivator control module 57 which the hybrid motivator control module 57 may use in determining the replacement generator control signal 58 as well as the storage controller signal 72. A motivator current sensor 81 may be used to monitor the magnitude and direction of the current to and from the motor-generator 17, i.e. the up stroke AC power 24 and the down stroke AC power 25, and to transmit a motivator current signal 85 to the hybrid motivator control module 57 for use in generating the replacement generator control signal 58 as well as the storage controller signal 72. The storage controller signal 72 from the hybrid motivator control module 57 to the energy storage controller 93 may control the portion, if any, of the combined down stroke DC power 111 that is diverted as surplus power 95 to the excess energy dissipation device 113.

Other DC or AC sensors may be incorporated in the hydraulic surface unit circuitry to further enhance the effectiveness and efficiency of the hybrid prime motivator system 11 of the present invention as well as the overall effectiveness and efficiency of the hydraulic surface unit, which will be known to persons of skill in the art in view of the disclosures of this specification and the drawings.

As described for the embodiment shown in FIG. 1, an energy loss calculator may be incorporated for the embodiment of FIG. 3 for computing the energy loss during each rod pump cycle and a cumulative energy loss for use in controlling the operation of the replacement energy motivator 29 so as to provide adequate power to a hydraulic surface unit for each rod pump cycle and to maintain the voltage and energy storage of the energy storage assembly 21. The hybrid motivator control module 57 may also monitor voltage, current or temperature at other locations in the hybrid prime motivator circuit 59 for use in controlling the operation of the hybrid prime motivator system 11 of the present invention.

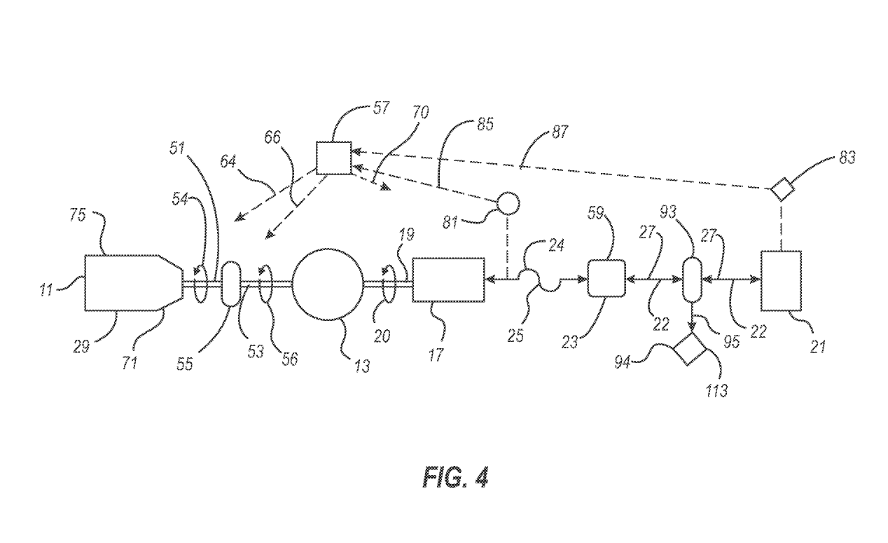

Referring now to FIG. 4, an alternative embodiment of a hybrid prime motivator system 11 of the present invention wherein both the motor-generator 17 and the replacement energy motivator 29 are directly coupled to the hydraulic pump 13 of the hydraulic surface unit as for the embodiment shown in FIG. 2. As shown and described for the embodiment shown in FIG. 2, the replacement energy motivator 29 is mechanically connected to the hydraulic pump 13 by replacement energy engagement device 55. For the embodiment of FIG. 4, a surplus energy dissipation assembly 94 is incorporated, which, for the embodiment shown, includes an energy storage controller 93 and an excess energy dissipation device 113 which may control the portion, if any, of the combined down stroke DC power 27 that is diverted as surplus power 95 to the excess energy dissipation device 113.

Referring further to FIGS. 1-4, alternative embodiments of hybrid prime motivator system 11 of the present invention may utilize a variable speed motor-generator 17. The hybrid motivator module 57 may use one or more sensor signals, such as a battery voltage signal 87 from a battery voltage sensor 83, a motivator current signal 85 from a motivator current sensor 81, or one or more voltage or current signals from sensors at other locations in the hybrid prime motivator circuit 59, to generate an inverter-converter signal 70 for use by the inverter-converter 23 in controlling the frequency, voltage or other characteristics of the up stroke AC power supplied to the motor-generator 17 during the rod pump up stroke, thereby controlling the speed of the motor-generator 17 during the rod pump up stroke. Similarly, the hybrid motivator module 57 may use one or more sensor signals, such as a battery voltage signal 87 from a battery voltage sensor 83, a motivator current signal 85 from a motivator current sensor 81, or one or more voltage or current signals from sensors at other locations in the hybrid prime motivator circuit 59, to generate an inverter-converter signal 70 for use by the inverter-converter 23 in controlling the frequency, voltage or other characteristics of the down stroke AC power produced by the motor-generator 17 during the rod pump down stroke, thereby controlling the speed of the motor-generator 17 during the rod pump down stroke.

The hybrid prime motivator system 11 of the present invention is particularly well suited for application with the rod pump regenerative hydraulic surface unit of U.S. Pat. No. 8,083,499 and U.S. Pat. No. 8,562,308 to Krug (the present inventor) et al., and U.S. Pat. No. 8,844,626 to Krug. For this preferred embodiment, the hybrid prime motivator system 11 incorporates a positive displacement hydraulic pump 13, preferably having a swash plate and swash plate pitch control for variable hydraulic fluid flow control.

Other embodiments and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. A hybrid prime motivator system for a hydraulic surface unit of a rod pump for an oil well or gas well, the hybrid prime motivator system comprising:
a hydraulic pump having hydraulic fluid flow control capability;
a motor-generator mechanically coupled to the hydraulic pump;
a hybrid energy system electrically connected to the motor-generator, the hybrid energy system having an energy supply capability for supplying energy to the motor-generator during a rod pump up stroke, an energy receiving capability for receiving and storing energy generated by the motor-generator during a rod pump down stroke, and a replacement energy generating capability for generating replacement energy to replace energy lost during successive rod pump cycles; and
a hybrid motivator control module.

2. A hybrid prime motivator system for a hydraulic surface unit of a rod pump as recited in claim 1 wherein the hybrid energy system comprises an energy storage assembly, a replacement engine, a replacement energy generation assembly, one or more replacement energy switches, and a hybrid prime motivator circuit electrically connecting the energy storage assembly, the replacement energy generator, the motor-generator, and the replacement energy switches.

3. A hybrid prime motivator system for a hydraulic surface unit of a rod pump as recited in claim 1 wherein the hybrid energy system comprises an energy storage assembly, a replacement engine mechanically connected to the hydraulic pump, and a hybrid prime motivator circuit electrically connecting the energy storage assembly and the motor-generator.

4. A hybrid prime motivator system for a hydraulic surface unit of a rod pump as recited in claim 1 wherein the motor-generator is an AC induction motor.

5. A hybrid prime motivator system for a hydraulic surface unit of a rod pump as recited in claim 1 wherein the motor-generator is an AC synchronous motor.

6. A hybrid prime motivator system for a hydraulic surface unit of a rod pump as recited in claim 1 wherein the motor-generator is a DC brush-less motor.

7. A hybrid prime motivator system for a hydraulic surface unit of a rod pump as recited in claim 1 wherein the motor-generator is a DC synchronous motor.

8. A hybrid prime motivator system for a hydraulic surface unit of a rod pump as recited in claim 1 wherein the hydraulic pump is a positive displacement pump having a swash plate with a swash plate pitch controller for hydraulic fluid flow control.

9. A hybrid prime motivator system for a hydraulic surface unit of a rod pump as recited in claim 1 wherein the energy storage assembly comprises one or more batteries, one or more capacitors, one or more energy storage switches, and an energy storage switch controller for directing the current to and from the one or more batteries and the one or more capacitors as needed to supply power to the motor-generator during the rod pump up stroke, and to receive and store power during the rod pump down stroke.

10. A hybrid prime motivator system for a hydraulic surface unit of a rod pump for an oil well or gas well, the hybrid prime motivator system comprising:
a positive displacement hydraulic pump having hydraulic fluid flow control capability;
a motor-generator mechanically coupled to the positive displacement hydraulic pump;
a hybrid energy system electrically connected to the motor-generator, the hybrid energy system having an energy supply capability for supplying energy to the motor-generator during a rod pump up stroke, an energy receiving capability for receiving and storing energy generated by the motor-generator during a rod pump down stroke, and a replacement energy generating capability for generating replacement energy to replace energy lost during successive rod pump cycles; and
a hybrid motivator control module.

11. A hybrid prime motivator system for a hydraulic surface unit of a rod pump as recited in claim 10 wherein the hybrid energy system comprises an energy storage assembly, a replacement engine, a replacement energy generation assembly, one or more replacement energy switches, and a hybrid prime motivator circuit electrically connecting the energy storage assembly, the replacement energy generator, the motor-generator, and the replacement energy switches.

12. A hybrid prime motivator system for a hydraulic surface unit of a rod pump as recited in claim 10 wherein the hybrid energy system comprises an energy storage assembly, a replacement engine mechanically connected to the hydraulic pump, and a hybrid prime motivator circuit electrically connecting the energy storage assembly and the motor-generator.

13. A hybrid prime motivator system for a hydraulic surface unit of a rod pump as recited in claim 10 wherein the motor-generator is an AC induction motor.

14. A hybrid prime motivator system for a hydraulic surface unit of a rod pump as recited in claim 10 wherein the motor-generator is an AC synchronous motor.

15. A hybrid prime motivator system for a hydraulic surface unit of a rod pump as recited in claim 10 wherein the motor-generator is a DC brush-less motor.

16. A hybrid prime motivator system for a hydraulic surface unit of a rod pump as recited in claim 10 wherein the motor-generator is a DC synchronous motor.

17. A hybrid prime motivator system for a hydraulic surface unit of a rod pump as recited in claim 10 wherein the positive displacement hydraulic pump has a swash plate with a swash plate pitch controller for hydraulic fluid flow control.

18. A hybrid prime motivator system for a hydraulic surface unit of a rod pump as recited in claim 10 wherein the energy storage assembly comprises one or more batteries, one or more capacitors, one or more energy storage switches, and an energy storage switch controller for directing the current to and from the one or more batteries and the one or more capacitors as needed to supply power to the motor-generator during the rod pump up stroke, and to receive and store power during the rod pump down stroke.

19. A hybrid energy system for a hydraulic pump of a hydraulic surface unit of a rod pump for an oil well or a gas well, the hydraulic pump being a positive displacement hydraulic pump having hydraulic fluid flow control, the hybrid energy system comprising:
a motor-generator having a capability for being mechanically coupled to the positive displacement hydraulic pump;
an energy storage assembly;
a replacement engine;
a replacement energy generation assembly;
energy storage controller; and
a hybrid energy system circuit electrically connecting the energy storage assembly, the replacement energy generation assembly, and the motor-generator.

20. A hybrid energy system for a hydraulic pump of a hydraulic surface unit of a rod pump for an oil well or a gas well as recited in claim 19 wherein the energy storage assembly comprises one or more energy storage switches and an energy storage switch controller, the hybrid energy system circuit electrically connecting the energy storage assembly, the replacement energy generation assembly, the motor-generator, and the one or more energy storage switches. comprising one or more replacement energy switches or energy storage switches,

21. A hybrid energy system for a hydraulic pump of a hydraulic surface unit of a rod pump for an oil well or a gas well as recited in claim 19 wherein the replacement energy generation assembly comprises one or more replacement energy switches and a replacement energy switch controller, the hybrid energy system circuit electrically connecting the energy storage assembly, the replacement energy generation assembly, the motor-generator, and the one or more replacement energy switches.

22. A hybrid energy system for a hydraulic pump of a hydraulic surface unit of a rod pump for an oil well or a gas well as recited in claim 19 wherein the energy storage assembly comprises one or more batteries, one or more capacitors, one or more energy storage switches, and an energy storage switch controller for directing the current to and from the one or more batteries and the one or more capacitors as needed to supply power to the motor-generator during the rod pump up stroke, and to receive and store power during the rod pump down stroke.

23. A hybrid energy system for a hydraulic pump of a hydraulic surface unit of a rod pump for an oil well or a gas well as recited in claim 19 wherein the energy storage assembly comprises a plurality of capacitors, a plurality of batteries, or a plurality of capacitors and a plurality of batteries, the capacitors and the batteries being interconnected by energy storage switches, the energy storage switches providing for parallel or series charging or discharging of selected batteries and capacitors so as to manage the discharging and charging of the energy storage assembly and to control the voltage of the up stroke DC power supplied to the inverter-converter.
